(19) United States
(12) Patent Application Publication
(10) Pub. No.: US 2012/0289186 A1
(43) Pub. Date: Nov. 15, 2012

(54) METHOD FOR DISCOVERING PREFERRED MOBILE COMPUTING LOCATIONS

(75) Inventor: Venkateswaran S. Ayalur, Lindenhurst, IL (US)

(73) Assignee: MOTOROLA MOBILITY, INC., Libertyville, IL (US)

(21) Appl. No.: 13/103,377

(22) Filed: May 9, 2011

(51) Int. Cl. H04W 4/00

(52) U.S. Cl. 455/405

(57) ABSTRACT

A method for discovering preferred mobile computing locations includes monitoring amount of time a mobile computing device is located within a cell tower region; and monitoring amount of time a mobile computing device is located within a Wi-Fi region. Afterwards, the method collects mobile computing device location data corresponding to the monitoring of cell tower region and Wi-Fi region; and analyzes the mobile computing device location data to determine amount of time and frequency of visits that the mobile computing device is in the cell tower and Wi-Fi regions. The above steps can be controlled via a processor within the mobile computing device such that a preferred mobile communication location is discovered for a user of the mobile computing device.

### FIELD OF INVENTION

This invention is directed to mobile computing devices and their users. More specifically, the invention is directed to enabling the mobile computing device to more closely align with a particular user's preferences.

### BACKGROUND

Adjusting behavior of a mobile computing device (MCD) to suit or benefit the user of the MCD according to that user's personal taste. For example, adjusting ringers or ringtones, turning on Wi-Fi in one location versus another location (e.g., home versus work locations), Bluetooth and GPS operation. All of these adjustments are usually done manually by the user and must be remembered to so.

Some solutions involve collecting locations based on GPS locations. However, GPS locations may not always be available, especially inside a building. Additionally, using GPS places a significant power drain on the battery of a MCD.

### BRIEF DESCRIPTION OF DRAWINGS

FIG. 1 illustrates a plurality of meaningful locations to an exemplary user of a MCD.

FIG. 2 illustrates a characterization of the meaningful locations with respect to the exemplary user of the MCD.

FIG. 3 illustrates an exemplary flowchart.

FIG. 4 illustrates an exemplary timing diagram.

### DETAILED DESCRIPTIONS

The following detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, brief summary or the following detailed description.

Before describing in detail embodiments that are in accordance with the present invention, it should be observed that the embodiments reside primarily in combinations of method steps and device components related to associating objects in an electronic device. Accordingly, the device components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the method, or device that comprises the element. Also, throughout this specification the term “key” has the broad meaning of any key, button or actuator having a dedicated, variable or programmable function that is actuated by a user.

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. In practice, one or more processor devices can carry out the described operations, tasks, and functions, and the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices. For the sake of brevity, conventional techniques related to signal processing, data transmission, signaling, network control, and other functional aspects of the systems (and the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in an embodiment of the subject matter.

A method for discovering preferred mobile computing locations includes monitoring amount of time a mobile computing device is located within a cell tower region; and monitoring amount of time a mobile computing device is located within a Wi-Fi region. Afterwards, the method collects mobile computing device location data corresponding to the monitoring of cell tower region and Wi-Fi region; and analyzes the mobile computing device location data to determine amount of time and frequency of visits that the mobile computing device is in the cell tower and Wi-Fi regions. The above steps can be controlled via a processor within the mobile computing device such that a preferred mobile computing location is discovered for a user of the mobile computing device. Cell ID and Wi-Fi network ID are employed herein and are described by way of example, however, it is also contemplated that physical sensors associated with the MCD may also be monitored to determine meaningful locations of the user. For example, infrared sensors, integrated Bluetooth systems, retina-scanning devices, and fingerprint devices. Just as important can be certain characteristics about the mobile computing device itself. For example, usage characteristics (e.g., phone calls, emails, text, game playing, remaining battery level, etc.) and mobile computing application selections at certain locations versus different usage characteristics and application selections at other locations. Consequently, meaningful or preferred locations can be determined without using battery draining geographical location technology, such as global positioning system (GPS), or Global Navigation Satellite System (GLONASS), or Beidou Satellite Navigation System.

An exemplary MCD can operate under a set of programmable instructions. A set of instructions, when executed, may cause the MCD to perform any one or more of the methodologies described herein. In some embodiments, the MCD operates as a standalone device. In some embodiments, the MCD may be connected (e.g., using a network) to other MCDs. In a networked deployment, the MCD may operate in the capacity of a server or a client user MCD in a server-client user network environment, or as a peer machine in server-client user network environment, or as a peer machine in a peer-to-peer (or distributed) network environment.

The MCD may comprise a server computer, a client user computer, a personal computer (PC), a tablet PC, a personal digital assistant, a portable phone on a wireless or cellular network, a laptop computer, a smartphone either alone or combined with a display device, a control system, a network router, or any machine capable of executing a set of instructions (sequential or otherwise) that specify actions to be taken by that machine, not to mention a mobile server. It will be understood by those ordinarily skilled in the art of mobile computing and communication devices and associated networks, either wired or wireless that the mobile computing device described herein includes broadly any electronic device that provides voice, video, and data communication. Further, while a single MCD may be illustrated, the term “mobile computing device” shall also be taken to include any collection of mobile computing devices that individually or jointly executed a set (or multiple sets) of instructions to perform any one or more methodologies discussed herein.

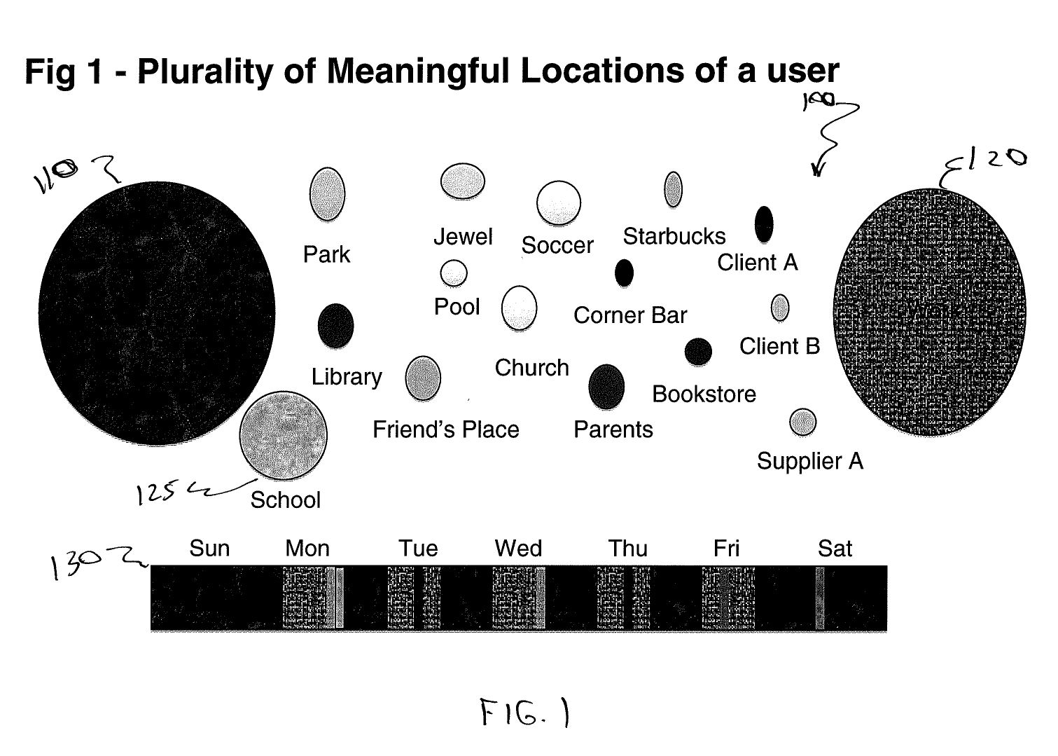

FIG. 1 illustrates a plurality of meaningful locations 100 of an exemplary user of a MCD. The plurality of meaningful locations 100 of a user of a MCD can include a home location 100, a work location 120, and a school location 125. Other possible locations are shown as well, for example library, parent's home, bookstore, church, soccer field, and a supplier's location. These locations are exemplary in nature and are not fully exhaustive. However, these locations make up a user's week in that they account for a percentage of the user's available time during week 130. A correlation of the time and frequency of where the user spends their time with the MCD in their possession can enable a determination of ‘meaningful locations’ for that user. These meaningful locations are also termed “preferred locations”.

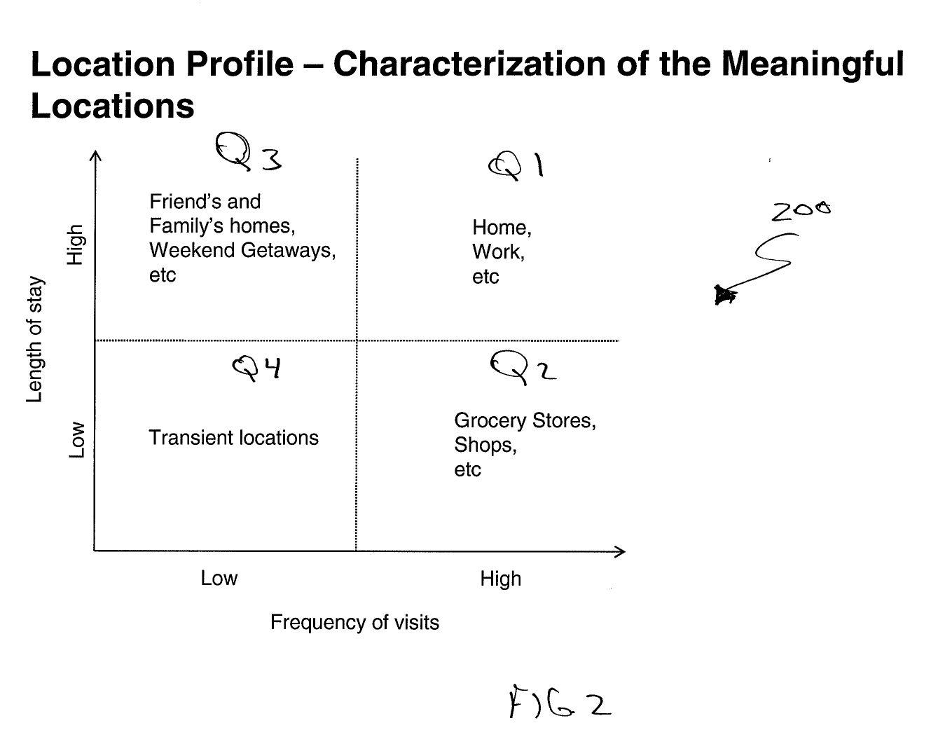

FIG. 2 illustrates the characterization of the meaningful locations based on the frequency of visits by the user when the MCD is in their possession and the length of stay by the user. In location profile 200, quadrant one reflects a high number of visits by the user and an extremely high length of stay while visiting. Examples of such visits can include the home and work locations. Quadrant two of location profile 200 also reflects a high number of times visited by the user, but the length of stay is substantially shorter in duration. Examples of these types of visits include trips to the grocery stores or other shops, for example.

Quadrant three of location profile 200 shows a substantially low number of visits, yet the stay when visited by the user is extremely long in duration. For example the visit to friends and relative's homes or weekend getaways. The final quadrant, quadrant four, shows both low number of visits and low durations of stay. Therefore, a user's transient visits would be one example. The transient location can be driving down the road or stopping at a rest area while on a long journey.

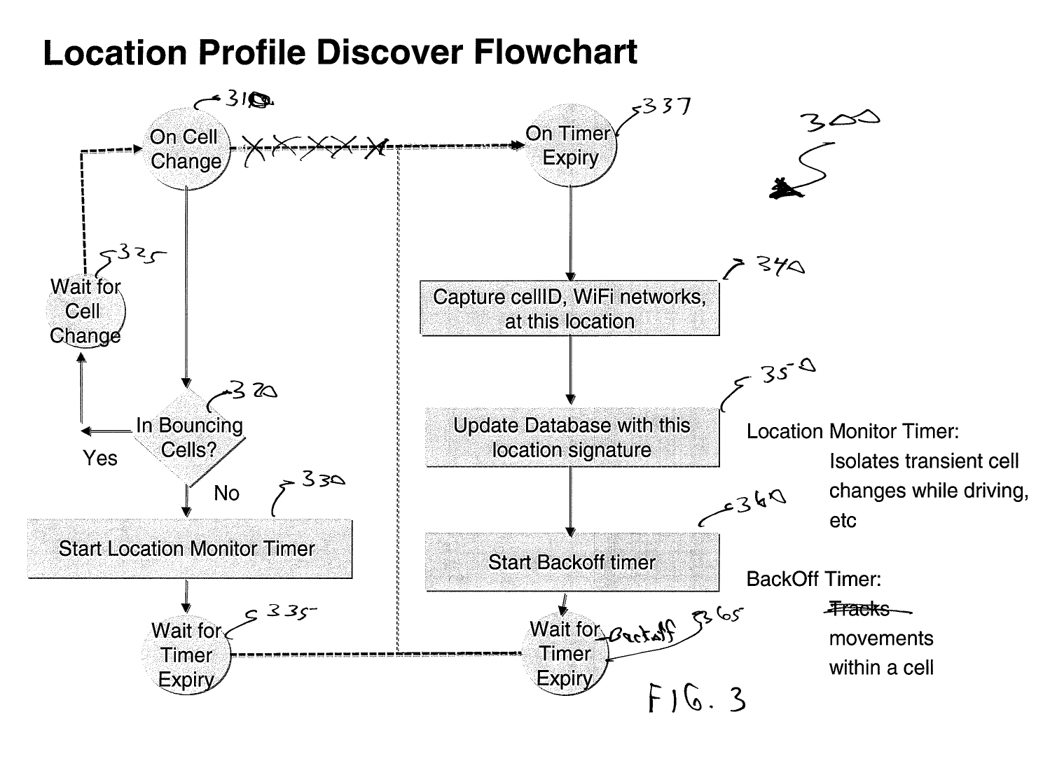

Flowchart 300 in FIG. 3 describes one exemplary method for determining meaningful or preferred location of a MCD user. Initial step 310 occurs at a cell tower change. Hence, monitoring of cell tower identification is employed. Step 320 inquires whether the user has moved into a region that is different than the cell identified in step 310. Each cell region has associated cell tower identification for a cell tower monitoring communication traffic within the cell tower region. On alternative may be that the user has not moved to a new cell region, therefore step 325 waits for a next cell tower identification change. The second alternative, shown in step 330, starts a location monitor timer as the user arrives at a new cell tower region. An initial waiting period expires in step 335. This initial expiration period allows for filtering or isolating transient cell tower ID changes associated with driving, for example. At step 337, a second time period is initiated for capturing data. Consequently, there is no need to constantly monitor and drain power as most conventional systems do. At step 340 cell tower identification and Wi-Fi network identification associated with the user's location is captured. Step 350 updates a database with a location signature that includes the cell ID and the Wi-Fi network ID. Step 360 starts a backoff timing period in which movements within one cell are determined to identify other meaningful locations for the user within in the same cell region. Step 365 shows expiration of the backoff timer. Cell ID and Wi-Fi network ID are employed herein, however, it is contemplated that physical sensors associated with the MCD may also be monitored to determine meaningful locations of the user. For example, infrared sensors, integrated Bluetooth systems, retina-scanning devices, and fingerprint devices.

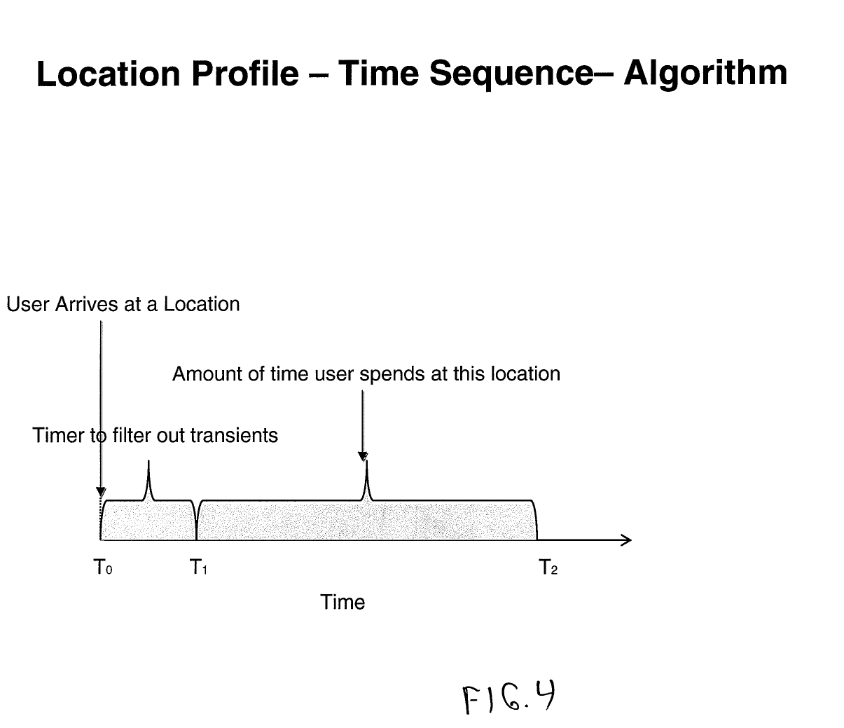

FIG. 4 shows a timing diagram that includes at least three time periods, T₀, T₁, and T₂. At T₀ the user arrives at a location with his MCD in possession. The timer begins running An elapsed period of time happens between the second time period, T₁ and T₀ (T₁-T₀). During this period, any transient location visits by the user are filtered out. A second elapsed time period between the third time period T₂ and T₁; (T₂-T₁), calculates the amount of time the user spends at one location.

Notably, once a location has been captured by the above methods, the location is not captured again, until the MCD moves out of the cell tower region or given an average duration period for the location; whichever time period may be lower. That is the number of times that the location is captured can be limited or restricted to reduce power consumption by a battery of the MCD. Specifically, the method employs an available Cell ID associated with the MCD without using additional current. However, when a change is detected and the MCD has a duration of N minutes, then the location information is captured.
It should be appreciated that a described process may include any number of additional or alternative tasks, the tasks shown in the figures need not be performed in the illustrated order, and a described process may be incorporated into a more comprehensive procedure or process having additional functionality not described in detail herein. Moreover, one or more of the tasks shown in a figure could be omitted from an embodiment of the respective process as long as the intended overall functionality remains intact. While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

It will be appreciated that some embodiments may be comprised of one or more generic or specialized processors (or “processing devices”) such as microprocessors, digital signal processors, customized processors and field programmable gate arrays (FPGAs) and unique stored program instructions or code (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a non-transitory machine readable storage device or medium having computer readable code stored thereon for programming a computer (e.g., comprising a processor) to perform a method as described and claimed herein. Examples of such non-transitory machine readable storage devices or mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

I claim:

1. A method for discovering preferred mobile computing locations, comprising the steps of:
monitoring amount of time a mobile computing device is located within a cell tower region;
monitoring amount of time a mobile computing device is located within a Wi-Fi region;
collecting mobile computing device location data corresponding to the monitoring of cell tower region and Wi-Fi region;
analyzing the mobile computing device location data to determine amount of time and frequency of visits that the mobile computing device is in the cell tower and Wi-Fi regions; and
controlling the above steps via a processor within the mobile computing device such that a preferred mobile communication location is discovered for a user of the mobile computing device.

2. The method according to claim 1, further comprising the steps of :
monitoring when the mobile computing device is determined to change from a first cell tower region to a second cell tower region;
determining amount of elapsed time after a change of location for the mobile computing device from the first cell tower region to the second cell tower region;
capturing corresponding Wi-Fi data in the second cell tower region;
storing the captured Wi-Fi data and cell tower region data in a database.

3. The method according to claim 1, further comprising the step of:
determining amount of usage for the mobile computing device within the second cell tower region and Wi-Fi region.

4. The method according to claim 2, wherein the stored Wi-Fi data and cell tower region data are employed to discover the preferred mobile computing device location for the user of the mobile computing device.

5. The method according to claim 1, further comprising the step of leveraging a Wi-Fi scan within the mobile computing device that is normally used for a purpose other than location-fixing.

6. The method according to claim 1, wherein a threshold period of time elapses prior to performing the monitoring of the cell tower region and Wi-Fi region.

7. The method according claim 6, further comprising monitoring amount of time and frequency of visits the mobile computing device is located within a cell tower region and Wi-Fi region.

8. The method according to claim 7, wherein the amount of time and frequency of visits monitored reveals an extended time for length of stay, high frequency visited location.

9. The method according to claim 7, wherein the amount of time and frequency of visits monitored reveals an extended time for length of stay, low frequency visited location.

10. The method according to claim 7, wherein the amount of time for length of stay and frequency of visits monitored reveals a brief time for length of stay, high frequency visited location.

11. The method according to claim 7, wherein the amount of time for length of stay and frequency of visits monitored reveals a brief time for length of stay, low frequency visited location.

12. A non-transitory machine readable storage device, having stored thereon a computer program that includes a plurality of code sections comprising:
code for monitoring amount of time a mobile computing device is located within a cell tower region;
code for monitoring amount of time a mobile computing device is located within a Wi-Fi region;
code for collecting mobile computing device location data corresponding to the monitoring of cell tower region and Wi-Fi region;
code for analyzing the mobile computing device location data to determine amount of time and frequency of visits that the mobile computing device is in the cell tower and Wi-Fi regions; and
code for controlling the above steps via a processor within the mobile computing device such that a preferred mobile communication location is discovered for a user of the mobile computing device.

13. The non-transitory machine readable storage device according to claim 12, further comprising additional code sections that include:
code for monitoring when the mobile computing device is determined to change from a first cell tower region to a second cell tower region;
code for determining amount of elapsed time after a change of location for the mobile computing device from the first cell tower region to the second cell tower region;
code for capturing corresponding Wi-Fi data in the second cell tower region;
code for storing the captured Wi-Fi data and cell tower region data in a database.

14. The non-transitory machine readable storage device according to claim 12, further comprising at least one additional code section that includes:
code for determining amount of usage for the mobile computing device within the second cell tower region and Wi-Fi region.

15. The non-transitory machine readable storage device according to claim 12, wherein the stored Wi-Fi data and cell tower region data are employed to discover the preferred mobile computing device location for the user of the mobile computing device.

16. The non-transitory machine readable storage device according to claim 12, further comprising code for leveraging a Wi-Fi scan within the mobile computing device that is normally used for a purpose other than location-fixing.

17. The non-transitory machine readable storage device according to claim 12, wherein a threshold period of time elapses prior to performing the monitoring of the cell tower region and Wi-Fi region.

18. The non-transitory machine readable storage device according to claim 12, further comprising code for monitoring amount of time and frequency of visits the mobile computing device is located within a cell tower region and Wi-Fi region.

19. The non-transitory machine readable storage device according to claim 12, wherein the amount of time and frequency of visits monitored reveals an extended time for length of stay, high frequency visited location.

20. A method for discovering preferred mobile computing locations, comprising the steps of:
monitoring usage of a mobile computing device while located within a cell tower region;
monitoring usage a mobile computing device while located within a Wi-Fi region;
collecting mobile computing device location data corresponding to the monitoring of cell tower region and Wi-Fi region;
analyzing the mobile computing device location data to determine amount of usage of the mobile computing device and applications running on the mobile computing device that the mobile computing device is in the cell tower and Wi-Fi regions; and
controlling the above steps via a processor within the mobile computing device such that a preferred mobile computing location is discovered for a user of the mobile computing device.
